(19) United States
(12) Patent Application Publication
(10) Pub. No.: US 2024/0348186 A1
(43) Pub. Date: Oct. 17, 2024

(54) METHOD FOR ESTIMATING ROTOR ANGLE AND ROTOR SPEED OF PERMANENT MAGNET SYNCHRONOUS MOTOR AND ASSOCIATED SYSTEM

(71) Applicant: Elite Semiconductor Microelectronics Technology Inc., Hsinchu (TW)

(72) Inventor: Ru-Chang Wu, Hsinchu (TW)

(73) Assignee: Elite Semiconductor Microelectronics Technology Inc., Hsinchu (TW)

(21) Appl. No.: 18/134,033

(22) Filed: Apr. 12, 2023

(51) Int. Cl. H02P 23/14; H02P 25/022

(52) U.S. Cl. CPC H02P 23/14; H02P 25/022

(57) ABSTRACT

A method for estimating a rotor angle and a rotor speed of a permanent magnet synchronous motor (PMSM) includes: receiving a d-axis voltage driving signal of the PMSM, and obtaining a first estimated rotor speed of the PMSM according to the d-axis voltage driving signal; receiving a speed command, and obtaining a second estimated rotor speed of the PMSM according to the speed command; performing a weighting adjustment operation upon the first estimated rotor speed and the second estimated rotor speed to obtain a third estimated rotor speed for estimating the rotor speed of the PMSM; and performing an integration operation upon the third estimated rotor speed to obtain an estimated rotor angle for estimating the rotor angle of the PMSM.

### BACKGROUND OF THE INVENTION

### 1. Field of the Invention

The present invention is related to a permanent magnet synchronous motor (PMSM), and more particularly, to a method for estimating a rotor angle and a rotor speed of the PMSM and an associated system.

### 2. Description of the Prior Art

For the control of a PMSM without a speed sensor, it is necessary to obtain an estimated rotor angle and an estimated rotor speed of the PMSM before subsequent control operations can be performed. For a conventional method, the rotor angle and the rotor speed of the PMSM will be estimated according to a back electromotive force (emf) signal (e.g. a d-axis voltage driving signal of the PMSM), which has an advantage of being easy to implement through hardware, and can achieve good speed control performance when the PMSM is operating at a high speed. However, under a condition that the PMSM is operating at a low speed, since the back emf signal is susceptible to interference, the accuracy of the conventional method for estimating the rotor angle and the rotor speed of the PMSM may decrease, which causes the inability to accurately control the rotational speed of the PMSM. As a result, a novel method for estimating a rotor angle and a rotor speed of the PMSM, which has a low-speed compensation mechanism to accurately estimate the rotor angle and the rotor speed of the PMSM when the PMSM is operating at a low speed, is urgently needed.

### SUMMARY OF THE INVENTION

It is one of the objectives of the present invention to provide a method for estimating a rotor angle and a rotor speed of a PMSM and an associated system, to address the above-mentioned issues.

According to an embodiment of the present invention, a method for estimating a rotor angle and a rotor speed of a PMSM is provided. The method comprises: receiving a d-axis voltage driving signal of the PMSM, and obtaining a first estimated rotor speed of the PMSM according to the d-axis voltage driving signal; receiving a speed command, and obtaining a second estimated rotor speed of the PMSM according to the speed command; performing a weighting adjustment operation upon the first estimated rotor speed and the second estimated rotor speed to obtain a third estimated rotor speed for estimating the rotor speed of the PMSM; and performing an integration operation upon the third estimated rotor speed to obtain an estimated rotor angle for estimating the rotor angle of the PMSM.

According to an embodiment of the present invention, a system for estimating a rotor angle and a rotor speed of a PMSM is provided. The system comprises a speed observer, a motor model, a weighting control circuit, and an integrator circuit. The speed observer is arranged to receive a d-axis voltage driving signal of the PMSM, and obtain a first estimated rotor speed of the PMSM according to the d-axis voltage driving signal. The motor model is arranged to receive a speed command, and obtain a second estimated rotor speed of the PMSM according to the speed command. The weighting control circuit is coupled to the speed observer and the motor model, and is arranged to perform a weighting adjustment operation upon the first estimated rotor speed and the second estimated rotor speed to obtain a third estimated rotor speed for estimating the rotor speed of the PMSM. The integrator circuit is coupled to the weighting control circuit, and is arranged to perform an integration operation upon the third estimated rotor speed to obtain an estimated rotor angle for estimating the rotor angle of the PMSM.

One of the benefits of the present invention is that, by the method for estimating a rotor angle and a rotor speed of a PMSM and an associated system provided by the present invention, under a condition that the PMSM is operating at a low speed, signal-to-noise ratio (SNR) can be improved, which makes estimation of the rotor angle and the rotor speed of the PMSM accurate. In addition, under a condition that the PMSM is operating at a high speed, electrical and/or mechanical frequency related interference sources can be reflected and the accuracy of estimating the rotor angle and the rotor speed of the PMSM can be improved at the same time. In this way, the rotational speed of the PMSM can be accurately controlled.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a motor device according to an embodiment of the present invention.

FIG. 2 is a diagram illustrating an estimation system according to an embodiment of the present invention.

FIG. 3 is a diagram illustrating a motor model according to an embodiment of the present invention.

FIG. 4 is a flow chart of a method for estimating a rotor angle and a rotor speed of a PMSM according to an embodiment of the present invention.

### DETAILED DESCRIPTION

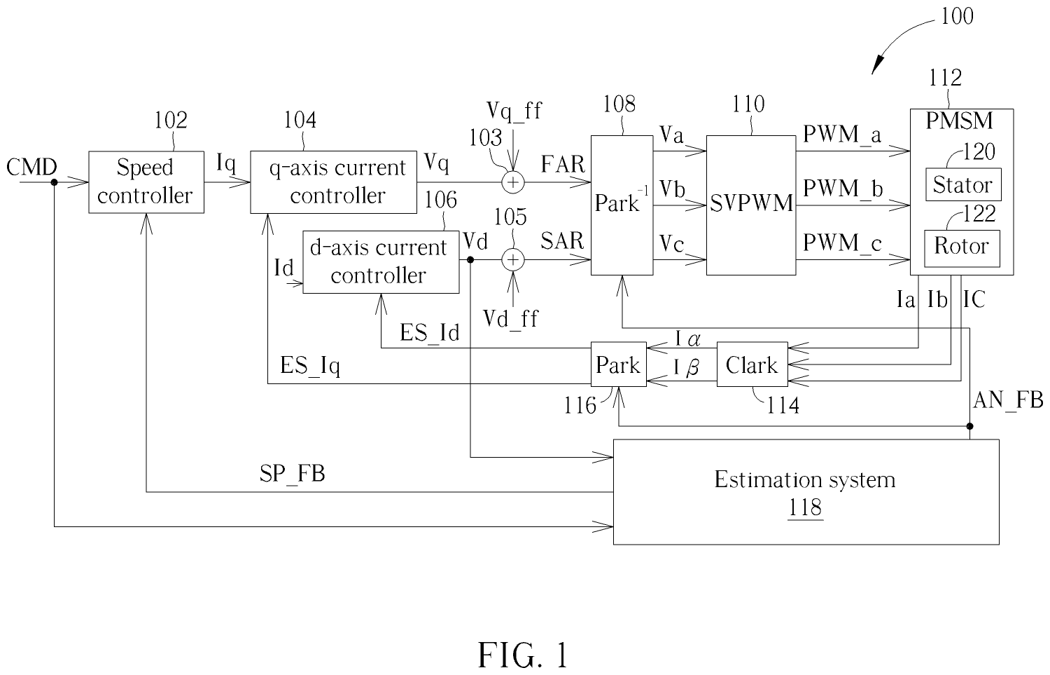

FIG. 1 is a block diagram of a motor device 100 according to an embodiment of the present invention. As shown in FIG. 1, the motor device 100 may include a speed controller 102, multiple addition circuits 103 and 105, a q-axis current controller 104, a d-axis current controller 106, an inverse park transform module (for brevity, labeled as “Park⁻¹” in FIG. 1) 108, a space-vector pulse width modulation (SVPWM) module 110, a permanent magnet synchronous motor (PMSM) 112, a clark transform module (for brevity, labeled as “Clark” in FIG. 1) 114, a park transform module (for brevity, labeled as “Park” in FIG. 1) 116, and an estimation system 118, wherein the PMSM 112 may include a stator 120 and a rotor 122, the stator 120 may be a three phase stator winding, and the rotor 122 may be a permanent magnet. The speed controller 102 may be arranged to receive a speed command CMD from a user or an external source and a feedback rotor speed SP_FB from the estimation system 118, and obtain a q-axis current reference signal Iq according to the speed command CMD and the feedback rotor speed SP_FB. For example, by the speed controller 102, the feedback rotor speed SP_FB may be subtracted from a rotor speed corresponding to the speed command CMD to generate a subtraction result, and the q-axis current reference signal Iq may be obtained according to the subtraction result.

The q-axis current controller 104 may be arranged to receive the q-axis current reference signal Iq from the speed controller 102 and an estimated q-axis current signal ES_Iq of the PMSM 112 from the park transform module 116, and compare the estimated q-axis current signal ES_Iq with the q-axis current reference signal Iq to generate a q-axis voltage driving signal Vq of the PMSM 112. Similarly, the d-axis current controller 106 may be arranged to receive a d-axis current reference signal Id (e.g. the d-axis reference current signal Id is equal to 0; i.e. Id=0) from the user or the external source and an estimated d-axis current signal ES_Id of the PMSM 112 from the park transform module 116, and compare the estimated d-axis current signal ES_Id with the d-axis current reference signal Id to generate a d-axis voltage driving signal Vd of the PMSM 112.

The addition circuit 103 may be arranged to receive the q-axis voltage driving signal Vq from the q-axis current controller 104 and a feed-forward q-axis voltage signal Vq_ff, and add the feed-forward q-axis voltage signal Vq_ff to the q-axis voltage driving signal Vq to generate a first addition result FAR (i.e. FAR=Vq+Vq_ff). The feed-forward q-axis voltage signal Vq_ff can be obtained by the following equation:

$${V}_{qff} = {R}_{s} * {I}_{d} + {ω}_{r} * {L}_{s} * {I}_{q}$$

wherein V_{qff} is the feed-forward q-axis voltage signal Vq_ff, Rₛ is a resistance value at the stator 120, I_{d} is the d-axis current reference signal Id, ωᵣ is a first estimated rotor speed FES_RS obtained by the estimation system 118, Lₛ is an inductance value at the stator 120, and I_{q} is the q-axis current reference signal Iq. Similarly, the addition circuit 105 may be arranged to receive the d-axis current reference signal Id from the d-axis current controller 106 and a feed-forward d-axis voltage signal Vd_ff, and add the feed-forward d-axis voltage signal Vd_ff to the d-axis current reference signal Id to generate a second addition result SAR (i.e. SAR=Vd+Vd_ff). The feed-forward d-axis voltage signal Vd_ff can be obtained by the following equation:

$${V}_{dff} = {R}_{s} * {I}_{q} + {ω}_{r} * {L}_{s} * {I}_{d}$$

wherein V_{dff} is the feed-forward d-axis voltage signal Vd_ff, Rₛ is the resistance value at the stator 120, I_{q} is the q-axis current reference signal Iq, ωᵣ is the first estimated rotor speed FES_RS obtained by the estimation system 118, Lₛ is an inductance value at the stator 120, and I_{d} is the d-axis current reference signal Id.

The inverse park transform module 108 may be arranged to receive the first addition result FAR, the second addition result SAR, and a feedback rotor angle AN_FB from the addition circuit 103, the addition circuit 105, and the estimation system 118, respectively, and perform an inverse park transform upon the first addition result FAR and the second addition result SAR according to the feedback rotor angle AN_FB to generate multiple three-phase voltage driving signals Va, Vb, and Vc. The SVPWM module 110 may be arranged to generate three-phase PWM signals PWM_a, PWM_b, and PWM_c according to the three-phase voltage driving signals Va, Vb, and Vc, for driving the PMSM 112. After the PMSM 112 is driven by the three-phase PWM signals PWM_a, PWM_b, and PWM_c, multiple three-phase current signals Ia, Ib, and Ic may be received by the clark transform module 114, and the clark transform module 114 may be arranged to perform a clark transform upon the three-phase current signals Ia, Ib, and Ic to generate multiple alpha/beta-domain current signals Iα and Iβ. The park transform module 116 may be arranged to receive the alpha/beta-domain current signals Ix and IB from the clark transform module 114 and the feedback rotor angle AN_FB from the estimation system 118, and perform a park transform upon the alpha/beta-domain current signals Ix and IB according to the feedback rotor angle AN_FB, to generate the estimated q-axis current signal ES_Iq and the estimated d-axis current signal ES_Id.

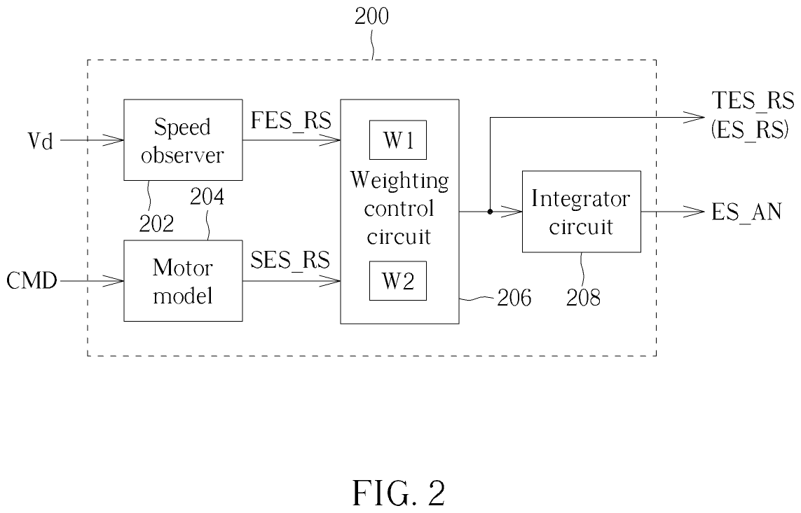

The estimation system 118 may be arranged to receive the d-axis voltage driving signal Vd and the speed command CMD, and generate an estimated rotor speed ES_RS and an estimated rotor angle ES_AN according to the d-axis voltage driving signal Vd and the speed command CMD, wherein the estimated rotor speed ES_RS may be regarded as the feedback rotor speed SP_FB, and the estimated rotor angle ES_AN may be regarded as the feedback rotor angle AN_FB. In detail, please refer to FIG. 2. FIG. 2 is a diagram illustrating an estimation system 200 according to an embodiment of the present invention, wherein the estimation system 118 shown in FIG. 1 may be implemented by the estimation system 200. As shown in FIG. 2, the estimation system 200 may include a speed observer 202, a motor model 204, a weighting control circuit 206, and an integrator circuit 208. The speed observer 202 may be arranged to receive the d-axis voltage driving signal Vd, and obtain the first estimated rotor speed FES_RS of the PMSM 112 according to the d-axis voltage driving signal Vd. Specifically, the speed observer 202 may obtain the first estimated rotor speed FES_RS by the following equation:

$${V}_{d} = {R}_{s} * {I}_{d} - {ω}_{r} * {L}_{s} * {I}_{q} + {ω}_{r} * {λ}_{f} * sin {θ}_{err}$$

wherein V_{d} is the d-axis voltage driving signal Vd, Rₛ is the resistance value at the stator 120, I_{d} is the d-axis current reference signal Id, ωᵣ is the first estimated rotor speed FES_RS, Lₛ is the inductance value at the stator 120, I_{q} is the q-axis current reference signal Iq, λ_{f} is a back electromotive force (emf) constant, and θₑᵣᵣ is an error angle between the estimated rotor angle ES_AN and an actual rotor angle.

It is assumed that the error angle between the estimated rotor angle ES_AN and the actual rotor angle is close to 0 and the d-axis current reference signal Id and the q-axis current reference signal Iq are approximately the same as the estimated d-axis current signal ES_Id and the estimated q-axis current signal ES_Iq, respectively. The above-mentioned equation can be simplified as follows:

$${ω}_{r} = \frac{{V}_{d}}{{λ}_{f} * {θ}_{err}}$$

wherein the first estimated rotor speed FES_RS is proportional to the d-axis voltage driving signal Vd.

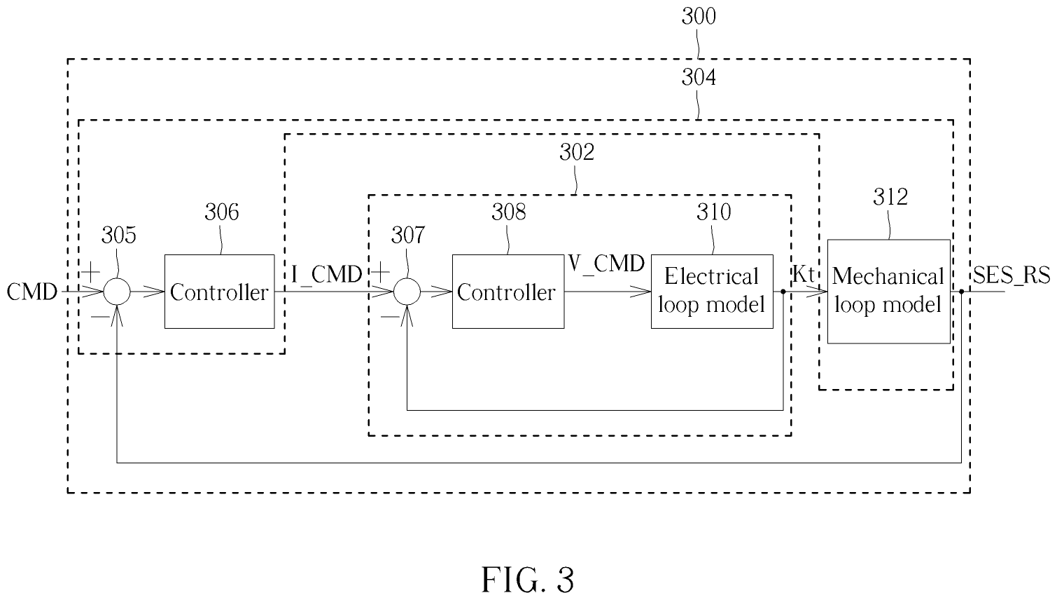

The motor model 204 may be an open-loop model, and may be arranged to receive the speed command CMD, and obtain a second estimated rotor speed SES_RS of the PMSM 112 according to the speed command CMD. Specifically, please refer to FIG. 3. FIG. 3 is a diagram illustrating a motor model 300 according to an embodiment of the present invention, wherein the motor model 204 shown in FIG. 2 may be implemented by the motor model 300. As shown in FIG. 3, the motor model 300 may include an electrical loop 302 and a mechanical loop 304, wherein the electrical loop 302 may include a subtraction circuit 307, a controller 308, and an electrical loop model 310, and the mechanical loop 304 may include a subtraction circuit 305, a controller 306, and a mechanical loop model 312. It should be noted that both of the controllers 306 and 308 can be implemented by a proportional integral (PI) controller, and the PI controller can perform a closed-loop operation in s-domain and can be indicated as following equation:

$${K}_{E} = {K}_{M} = \frac{{K}_{ps} + {K}_{i}}{s}$$

wherein K_{E} corresponds to the controller 308, K_{M} corresponds to the controller 306, Kₚₛ is a controller proportional constant, and Kᵢ is a controller integral constant.

The subtraction circuit 305 may be arranged to subtract an output of the mechanical loop model 312 from the speed command CMD, and then the controller 306 may be arranged to transfer an output of the subtraction circuit 305 into a current command I_CMD. The subtraction circuit 307 may be arranged to subtract an output of the electrical loop model 310 from the current command I_CMD, and then the controller 308 may be arranged to transfer an output of the subtraction circuit 307 into a voltage command V_CMD. It is assumed that the electrical loop model 310 is a combination of a resistor R and an inductor L, and the voltage command V_CMD may be transmitted to the electrical loop model 310 for current control. The electrical loop model 310 may be obtained by the following equation in t-domain:

$$V ( t ) = L * \frac{dI}{d t} + I ( t ) * R$$

wherein V(t) represents a voltage value in the t-domain that corresponds to the voltage command V_CMD, L is an inductance value of the inductor L, I(t) represents a current value in the t-domain that corresponds to a current output by the electrical loop model 310, R is a resistance value of the resistor R, a Laplace transform can be performed upon the above-mentioned equation to obtain an equation in the s-domain as follows:

$$V ( s ) = ( L * s + R ) * I ( s ) ,$$

and the electrical loop model 310 (denoted by “G_{E}”) can be obtained by the following equation:

$${G}_{E} = \frac{I ( s )}{V ( s )} = \frac{1}{L * s + R}$$

As a result, a closed-loop equation tf_{E} of the electrical loop 302 can be expressed as follows:

$${tf}_{E} = \frac{{K}_{E} * {G}_{E}}{1 + {K}_{E} * {G}_{E}}$$

wherein K_{E} is the above-mentioned equation for performing the closed-loop operation by the controller 308, and G_{E} is the above-mentioned equation corresponding to the electrical loop model 310.

For the mechanical loop 304, a torque of the mechanical loop model 312 can be obtained by the following equation in the t-domain:

$$T ( t ) = J * α + B * ω ( t ) = J * \frac{d ω}{d t} + B * ω ( t )$$

wherein T(t) represents a torque value in the t-domain that corresponds to the torque of the mechanical loop model 312, J is a rotational inertia of the mechanical loop model 312, B is a friction coefficient of the mechanical loop model 312, α is an angular acceleration of the mechanical loop model 312, ω(t) is an angular velocity in the t-domain of the mechanical loop model 312, a Laplace transform can be performed upon the above-mentioned equation, to obtain an equation in the s-domain as follows:

$$T ( s ) = ( J * s + B ) * ω ( t ) ,$$

and the mechanical loop model 312 (denoted by “G_{M}”) can be obtained by the following equation:

$${G}_{M} = \frac{ω ( s )}{T ( s )} = \frac{1}{J * s + B}$$

As a result, a closed-loop equation tf_{M} of the mechanical loop 304 can be expressed as follows:

$${tf}_{M} = \frac{{K}_{M} * {G}_{M}}{1 + {K}_{M} * {G}_{M}}$$

wherein K_{M} is the above-mentioned equation for performing the closed-loop operation by the controller 306, and G_{M} is the above-mentioned equation corresponding to the mechanical loop model 312.

The motor model 300 (denoted by “MOTOR_M”) can be obtained by multiplying the closed-loop equation tf_{E} of the electrical loop 302, a torque constant Kt for performing transfer between the current and the torque, and the closed-loop equation tf_{M} of the mechanical loop 304 (i.e.

$$MOTOR\_M = {tf}_{E} ⋆ Kt * {tf}_{M} = \frac{{K}_{E} * {G}_{E}}{1 + {K}_{E} * {G}_{E}} * Kt * \frac{{K}_{M} * {G}_{M}}{1 + {K}_{M} * {G}_{M}} ) .$$

In addition, it is assumed that K_{E}*G_{E} is much larger than 1 (i.e. K_{E}*G_{E}>>1) and Kt*K_{M}*G_{M} is also much larger than 1 (i.e. Kt*K_{M}*G_{M}>>1). The motor model 300 can be simplified by the following equation:

$$MOTOR\_M = \frac{SES\_RS}{CMD} = \frac{{K}_{E} * {G}_{E}}{1 + {K}_{E} * {G}_{E}} * \frac{K t * {K}_{M} * {G}_{M}}{1 + {K}_{M} * {G}_{M}} \approx 1$$

In this way, after receiving the speed command CMD, the motor model 300 can obtain the second estimated rotor speed SES_RS of the PMSM 112 according to the speed command CMD.

Please refer back to FIG. 2. Considering a case where the estimation system 200 is modified to only include the speed observer 202 and the integrator circuit 208. In this case, when the PMSM 112 is operating at a high speed, good speed control performance of the PMSM 112 can be achieved by the estimation system 200. However, when the PMSM 112 is operating at a low speed, the d-axis voltage driving signal Vd will be too small, which makes the d-axis voltage driving signal Vd susceptible to interference, and makes a signal-to-noise ratio (SNR) too low. Therefore, the estimation system 200 is unable to accurately obtain the first estimated rotor speed FES_RS of the PMSM 112 according to the d-axis voltage driving signal Vd, which causes the inability to accurately control the rotational speed of the PMSM 112. Therefore, the PMSM 112 may fail to start and reverse.

Considering another case where the estimation system 200 is modified to only include the motor model 204 and the integrator circuit 208. In this case, the PMSM 112 may fail to start and be out of synchronism. When the PMSM 112 is operating at a low speed, the motor model 204 has a longer time to build up the magnetic field, which makes the difference between the second estimated rotor speed SES_RS of the PMSM 112 and the actual rotor speed smaller. However, when the PMSM 112 is operating at a high speed, the motor model 204 cannot reflect electrical and/or mechanical frequency related interference sources (e.g. cogging, friction, uneven magnetization, overshoot, or delay), which will cause poor transient response of the PMSM 112.

To solve the above-mentioned issues, in this embodiment, the estimation system 200 further includes the weighting control circuit 206. The weighting control circuit 206 may be coupled to the speed observer 202 and the motor model 204, and may be arranged to perform a weighting adjustment operation upon the first estimated rotor speed FES_RS and the second estimated rotor speed SES_RS to obtain a third estimated rotor speed TES_RS, wherein the third estimated rotor speed TES_RS may be regarded as the estimated rotor speed ES_RS and transmitted from the estimation system 118 to the speed controller 102 for performing the speed feedback operation. For example, the weighting control circuit 206 is a processor, and the processor can load and execute program code to implement an algorithm for performing the weighting adjustment operation. It is assumed that a first weighting value W1 corresponds to the first estimated rotor speed FES_RS, and a second weighting value W2 corresponds to the second estimated rotor speed SES_RS, wherein a sum of first weighting value W1 and the second weighting value W2 is equal to 1 (i.e. W1+W2=1). The weighting control circuit 206 may be arranged to multiply the first weighting value W1 and the first estimated rotor speed FES_RS to generate a first multiplication result, multiply the second weighting value W2 and the second estimated rotor speed SES_RS to generate a second multiplication result, and combine the first multiplication result and the second multiplication result to generate the third estimated rotor speed TES_RS (i.e. TES_RS=W1*FES_RS+W2*SES_RS).

In this embodiment, the first weighting value W1 and the second weighting value W2 are dynamically adjusted by the weighting control circuit 206 according to the rotor speed of the PMSM 112. For example, the first weighting value W1 can be designed as a function of a weight ω (e.g.

$$\frac{ω}{1 + ω} ) ,$$

and the second weighting value W2 can be designed as another function of the weight ω (e.g.

$$\frac{1}{1 + ω} ) .$$

When the PMSM 112 is operating at a low speed, the weighting control circuit 206 may decrease a value of the weight ω (i.e. increase the second weighting value W2 and decrease the first weighting value W1). When the PMSM 112 is operating at a high speed, the weighting control circuit 206 may increase the value of the weight ω (i.e. increase the first weighting value W1 and decrease the second weighting value W2). In this way, when the PMSM 112 is operating at a low speed, a low-speed compensation mechanism can be achieved by increasing the second weighting value W2 corresponding to the motor model 204, which can improve the SNR and therefore make the estimation of the rotor speed and the rotor angle of the PMSM 112 accurate. When the PMSM 112 is operating at a high speed, the electrical and/or mechanical frequency related interference sources can be reflected and the estimation of the rotor speed and the rotor angle of the PMSM 112 can be made accurate at the same time by increasing the first weighting value W1 corresponding to the speed observer 202.

In some embodiments, each of the first weighting value W1 and the second weighting value W2 is directly set as 0.5. That is, the third estimated rotor speed TES_RS is equal to half of a sum of the first estimated rotor speed FES_RS and the second estimated rotor speed SES_RS (i.e.

$$TES\_RS = \frac{FES\_RS + SES\_RS}{2} ) .$$

For example, under a condition that the first weighting value W1 is designed as the function

$$\frac{ω}{1 + ω}$$

of the weight ω and the second weighting value W2 is designed as the function

$$\frac{1}{1 + ω}$$

of the weight ω, the value of the weight ω can be directly set as 1 by the weighting control circuit 206.

In some embodiments, a cutoff rotor speed can be set by the weighting control circuit 206, and the weighting control circuit 206 may perform the weighting adjustment operation upon the first estimated rotor speed FES_RS and the second estimated rotor speed SES_RS to obtain the third estimated rotor speed TES_RS in response to the rotor speed of PMSM 112 being smaller than the cutoff rotor speed. That is, when the rotor speed of PMSM 112 is smaller than the cutoff rotor speed, the weighting control circuit 206 may dynamically adjust the first weighting value W1 corresponding to the first estimated rotor speed FES_RS and the second weighting value W2 corresponding to the second estimated rotor speed SES_RS. In addition, in response to the rotor speed of PMSM 112 being not smaller than the cutoff rotor speed, the weighting control circuit 206 may directly set the first estimated rotor speed FES_RS as the third estimated rotor speed TES_RS. That is, when the rotor speed of PMSM 112 is not smaller than the cutoff rotor speed, the weighting control circuit 206 does not perform the weighting adjustment operation upon the first estimated rotor speed FES_RS and the second estimated rotor speed SES_RS, and bypasses the first estimated rotor speed FES_RS to serve as the third estimated rotor speed TES_RS.

The integrator circuit 208 may be coupled to the weighting control circuit 206, and may be arranged to perform an integration operation upon the third estimated rotor speed TES_RS to obtain the estimated rotor angle ES_AN, wherein the estimated rotor angle ES_AN may be utilized to perform a position feedback operation for the PMSM 112. For example, in FIG. 1, the estimated rotor angle ES_AN may be regarded as the feedback rotor angle AN_FB and transmitted from the estimation system 118 to the inverse park module 108 and the park module 116 for performing the position feedback operation.

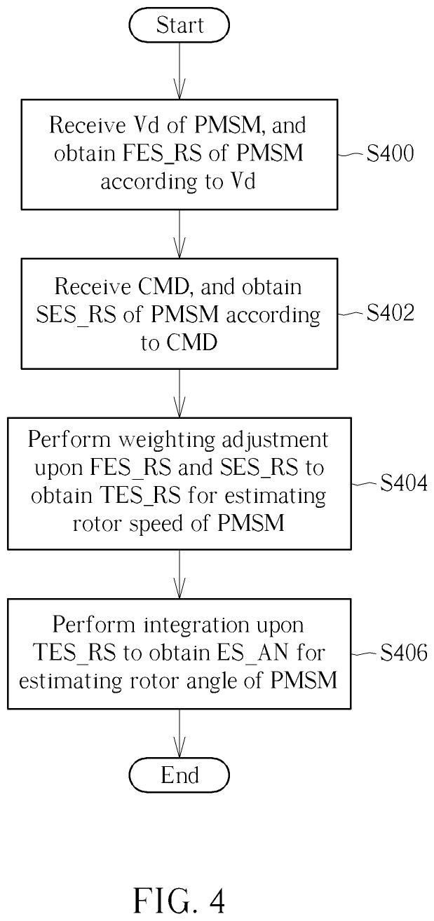

FIG. 4 is a flow chart of a method for estimating a rotor angle and a rotor speed of a PMSM according to an embodiment of the present invention. Provided that the result is substantially the same, the steps are not required to be executed in the exact order shown in FIG. 4. For example, the method shown in FIG. 4 may be employed by the estimation systems 118/200 shown in FIGS. 1 and 2.

In Step S400, the d-axis voltage driving signal Vd of the PMSM 112 is received, and the first estimated rotor speed FES_RS of the PMSM 112 is obtained according to the d-axis voltage driving signal Vd.

In Step S402, the speed command CMD is received, and the second estimated rotor speed SES_RS of the PMSM 112 is obtained according to the speed command CMD.

In Step S404, a weighting adjustment operation is performed upon the first estimated rotor speed FES_RS and the second estimated rotor speed SES_RS to obtain the third estimated rotor speed TES_RS for estimating the rotor speed of the PMSM 112.

In Step S406, an integration operation is performed upon the third estimated rotor speed TES_RS to obtain the estimated rotor angle ES_AN for estimating the rotor angle of the PMSM 112.

Since a person skilled in the pertinent art can readily understand details of the steps after reading above paragraphs directed to the estimation systems 118/200 shown in FIGS. 1 and 2, further description is omitted here for brevity.

In summary, by the method for estimating a rotor angle and a rotor speed of a PMSM and an associated system provided by the present invention, under a condition that the PMSM is operating at a low speed, the SNR can be improved, which makes estimation of the rotor angle and the rotor speed of the PMSM accurate. In addition, under a condition that the PMSM is operating at a high speed, electrical and/or mechanical frequency related interference sources can be reflected and the accuracy of estimating the rotor angle and the rotor speed of the PMSM can be improved at the same time. In this way, the rotational speed of the PMSM can be accurately controlled.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for estimating a rotor angle and a rotor speed of a permanent magnet synchronous motor (PMSM), comprising:
receiving a d-axis voltage driving signal of the PMSM, and obtaining a first estimated rotor speed of the PMSM according to the d-axis voltage driving signal;
receiving a speed command, and obtaining a second estimated rotor speed of the PMSM according to the speed command;
performing a weighting adjustment operation upon the first estimated rotor speed and the second estimated rotor speed to obtain a third estimated rotor speed for estimating the rotor speed of the PMSM; and
performing an integration operation upon the third estimated rotor speed to obtain an estimated rotor angle for estimating the rotor angle of the PMSM.

2. The method of claim 1, wherein a first weighting value corresponds to the first estimated rotor speed, a second weighting value corresponds to the second estimated rotor speed, and the step of performing the weighting adjustment operation upon the first estimated rotor speed and the second estimated rotor speed to obtain the third estimated rotor speed for estimating the rotor speed of the PMSM comprises:
multiplying the first weighting value and the first estimated rotor speed to generate a first multiplication result;
multiplying the second weighting value and the second estimated rotor speed to generate a second multiplication result; and
combining the first multiplication result and the second multiplication result to generate the third estimated rotor speed.

3. The method of claim 2, further comprising:
dynamically adjusting the first weighting value and the second weighting value according to the rotor speed of the PMSM.

4. The method of claim 2, wherein a sum of the first weighting value and the second weighting value is equal to 1, and the method further comprises:
setting each of the first weighting value and the second weighting value as 0.5.

5. The method of claim 1, wherein the step of performing the weighting adjustment operation upon the first estimated rotor speed and the second estimated rotor speed to obtain the third estimated rotor speed for estimating the rotor speed of the PMSM is performed in response to the rotor speed of PMSM being smaller than a cutoff rotor speed; and the method further comprises
in response to the rotor speed of PMSM being not smaller than the cutoff rotor speed, setting the first estimated rotor speed as the third estimated rotor speed.

6. A system for estimating a rotor angle and a rotor speed of a permanent magnet synchronous motor (PMSM), comprising:
a speed observer, arranged to receive a d-axis voltage driving signal of the PMSM, and obtain a first estimated rotor speed of the PMSM according to the d-axis voltage driving signal;
a motor model, arranged to receive a speed command, and obtain a second estimated rotor speed of the PMSM according to the speed command;
a weighting control circuit, coupled to the speed observer and the motor model, and arranged to perform a weighting adjustment operation upon the first estimated rotor speed and the second estimated rotor speed to obtain a third estimated rotor speed for estimating the rotor speed of the PMSM; and
an integrator circuit, coupled to the weighting control circuit, and arranged to perform an integration operation upon the third estimated rotor speed to obtain an estimated rotor angle for estimating the rotor angle of the PMSM.

7. The system of claim 6, wherein a first weighting value corresponds to the first estimated rotor speed, a second weighting value corresponds to the second estimated rotor speed, and the weighting control circuit is further arranged to:
multiply the first weighting value and the first estimated rotor speed to generate a first multiplication result;
multiply the second weighting value and the second estimated rotor speed to generate a second multiplication result; and
combine the first multiplication result and the second multiplication result to generate the third estimated rotor speed.

8. The system of claim 7, wherein the weighting control circuit is further arranged to dynamically adjust the first weighting value and the second weighting value according to the rotor speed of the PMSM.

9. The system of claim 7, wherein a sum of the first weighting value and the second weighting value is equal to 1, and the weighting control circuit is further arranged to:
set each of the first weighting value and the second weighting value as 0.5.

10. The system of claim 6, wherein the weighting control circuit performs the weighting adjustment operation upon the first estimated rotor speed and the second estimated rotor speed to obtain the third estimated rotor speed for estimating the rotor speed of the PMSM in response to the rotor speed of PMSM being smaller than a cutoff rotor speed; and the is weighting control circuit further arranged to:
in response to the rotor speed of PMSM being not smaller than the cutoff rotor speed, set the first estimated rotor speed as the third estimated rotor speed.
